(19) United States
(12) Patent Application Publication
(10) Pub. No.: US 2024/0401380 A1
(43) Pub. Date: Dec. 5, 2024

(54) LID OPENING AND CLOSING DEVICE

(71) Applicant: U-SHIN LTD., Nagano (JP)

(72) Inventor: Yuki TANAKA, Hiroshima (JP)

(21) Appl. No.: 18/691,564

(22) PCT Filed: Mar. 29, 2022
(86) PCT No.: PCT/JP2022/015665

§ 371 Date: Mar. 13, 2024

(30) Foreign Application Priority Data
Sep. 24, 2021 (JP) 2021-155989

(51) Int. Cl. E05F 15/71; E05B 81/06; E05B 81/18; E05B 81/30; E05B 83/34; E05F 15/614

(52) U.S. Cl. CPC E05F 15/71; E05B 81/06; E05B 83/34; E05F 15/614; E05B 81/18; E05B 81/30; E05Y 2201/624; E05Y 2201/638; E05Y 2900/534

(57) ABSTRACT

A lid opening and closing device includes a base to which a receiving portion is attached, a lid capable of moving between closed and open positions, a drive mechanism including a drive source causing the lid to perform an opening operation, a first operation receiving unit receiving an opening operation and outputting a first signal, a water detection unit outputting a second signal when detecting water outside an automobile, and a control unit controlling the drive mechanism based on input states of the first and signal signals. The control unit executes the opening operation of the lid by the drive mechanism when the first signal is input while the second signal is in a non-input state, and does not execute the opening operation of the lid by the drive mechanism even when the first signal is input while the second signal is in an input state.

### TECHNICAL FIELD

The present invention relates to a lid opening and closing device.

### BACKGROUND ART

Patent Document 1 discloses a lid opening and closing device used for an electric automobile. The lid opening and closing device includes a power supply connector to which a charging plug is connected, and a drive mechanism including a drive source for opening and closing a lid. The drive mechanism automatically opens and closes the lid by operating an operation unit provided on a remote key.

### PRIOR ART DOCUMENT

### Patent Document

Patent Document 1: JP-A-2014-210473

### SUMMARY OF THE INVENTION

### Problems to be Solved by the Invention

In the lid opening and closing device of Patent Document 1, when the lid is opened by an erroneous operation in rainy weather or during car washing, water that has entered the lid may adhere to the power supply connector, leading to failure. Even in a receiving portion that supplies liquid fuel or gas fuel other than electricity, it is not preferable that water infiltrates. Therefore, the lid opening and closing device of Patent Document 1 has room for improvement in preventing erroneous opening of the lid.

An object of the present invention is to provide a lid opening and closing device capable of preventing erroneous opening of a lid and preventing unintended infiltration of water into the lid.

### Solutions to the Problems

The present invention provides a lid opening and closing device including: a base arranged inside an opening portion of a panel and to which a receiving portion is attached so as to be located in the opening portion; a lid attached to the base so as to allow movement between a closed position where the opening portion is closed and an open position where the opening portion is opened; a drive mechanism including a drive source capable of executing an opening operation of moving the lid at the closed position to the open position; a first operation receiving unit that receives an opening operation for causing the lid to perform the opening operation and outputs a first signal; a water detection unit that outputs a second signal when detecting water outside the vehicle; and a control unit that controls the drive mechanism based on input states of the first signal and the second signal, in which the control unit executes the opening operation of the lid by the drive mechanism when the first signal is input while the second signal is in a non-input state, and does not execute the opening operation of the lid by the drive mechanism even when the first signal is input while the second signal is in an input state.

When the first signal is input from the first operation receiving unit while the second signal from the water detection unit is in the non-input state, the control unit executes the opening operation of the lid by the drive mechanism. That is, when a user performs the opening operation when there is no water outside the vehicle, the lid can be automatically opened by the drive mechanism. Therefore, convenience at the time of refueling the automobile can be improved.

When the second signal from the water detection unit is in the input state, the control unit does not execute the opening operation of the lid by the drive mechanism even if the first signal is received from the first operation receiving unit. That is, even if the opening operation is erroneously performed when there is water outside the vehicle, the lid is not opened by the drive mechanism. Therefore, erroneous opening of the lid can be prevented, and unintended infiltration of water into the lid can be prevented.

### Effects of the Invention

In the present invention, erroneous opening of the lid can be prevented, and unintended infiltration of water into the lid can be prevented.

### BRIEF DESCRIPTION OF THE DRAWINGS

FIG. 1 is a side view of an automobile to which a lid opening and closing device according to an embodiment of the present invention is mounted.

FIG. 2 is a perspective view of the lid opening and closing device according to the embodiment of the present invention.

FIG. 3 is a block diagram of the lid opening and closing device of FIG. 2.

FIG. 4 is a cross-sectional view taken along line IV-IV of FIG. 2.

FIG. 5 is a cross-sectional view of the lid opening and closing device with a lid closed, similar to FIG. 4.

FIG. 6 is an exploded perspective view of the lid opening and closing device excluding a receiving portion as viewed from a vehicle interior side.

FIG. 7 is an enlarged cross-sectional view of a portion VII in FIG. 4.

FIG. 8 is an enlarged cross-sectional view of a portion VIII in FIG. 5.

FIG. 9 is a cross-sectional view taken along line IX-IX of FIG. 5.

FIG. 10 is an exploded perspective view of an arm and a drive mechanism.

FIG. 11 is a partial cross-sectional view taken along line XI-XI of FIG. 9.

FIG. 12 is a partial cross-sectional view similar to FIG. 11 in a state where the lid is opened.

FIG. 13 is a partial cross-sectional view taken along line XIII-XIII of FIG. 9.

FIG. 14A is a graph showing movements of the arm and a lock member during an opening operation of the lid.

FIG. 14B is a graph showing movements of the arm and the lock member at the time of a closing operation of the lid.

FIG. 15 is a flowchart of lid opening and closing processing by a control unit.

### DETAILED DESCRIPTION

Hereinafter, an embodiment of the present invention will be described with reference to the accompanying drawings.

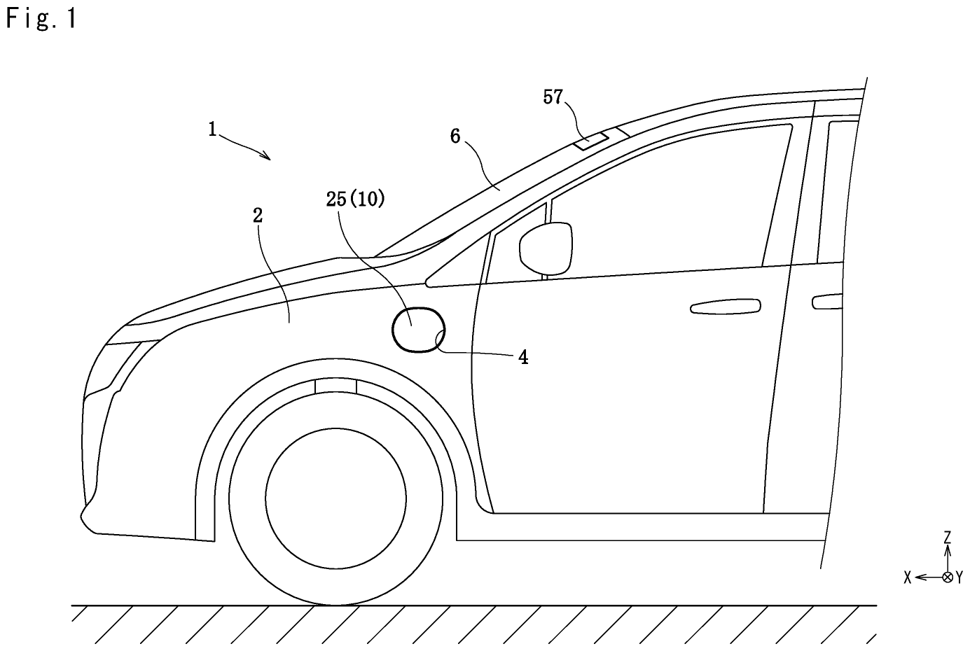

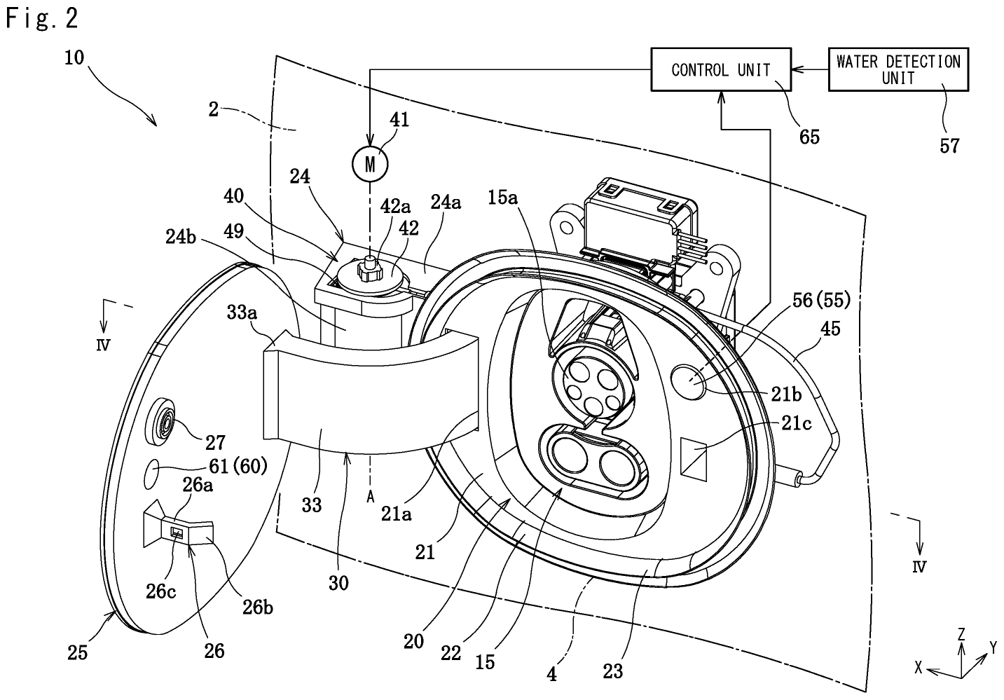

FIGS. 1 and 2 show a lid opening and closing device 10 according to an embodiment of the present invention mounted on an automobile 1. Referring to FIG. 2, the lid opening and closing device 10 includes a power supply connector 15 to which a charging plug (not shown) is connected, and is attached to a side panel (panel) 2 of the automobile. The power supply connector 15 is a receiving portion for supplying electricity. However, the receiving portion may be configured to be replenished with any of liquid fuel such as gasoline and light oil, and gaseous fuel such as hydrogen and LP gas instead of the power supply connector 15.

An X direction described in each drawing cited in the following description is an automobile length direction of the automobile 1, a Y direction is an automobile width direction of the automobile 1, and a Z direction is an automobile height direction of the automobile 1. In each drawing, the direction indicated by the arrow in the X direction is the front side, and the direction opposite to the arrow is the rear side. The direction indicated by the arrow in the Y direction is a vehicle interior side (inner side), and the direction opposite to the arrow is a vehicle exterior side (outer side). The direction indicated by the arrow in the Z direction is the upper side, and the direction opposite to the arrow is the lower side.

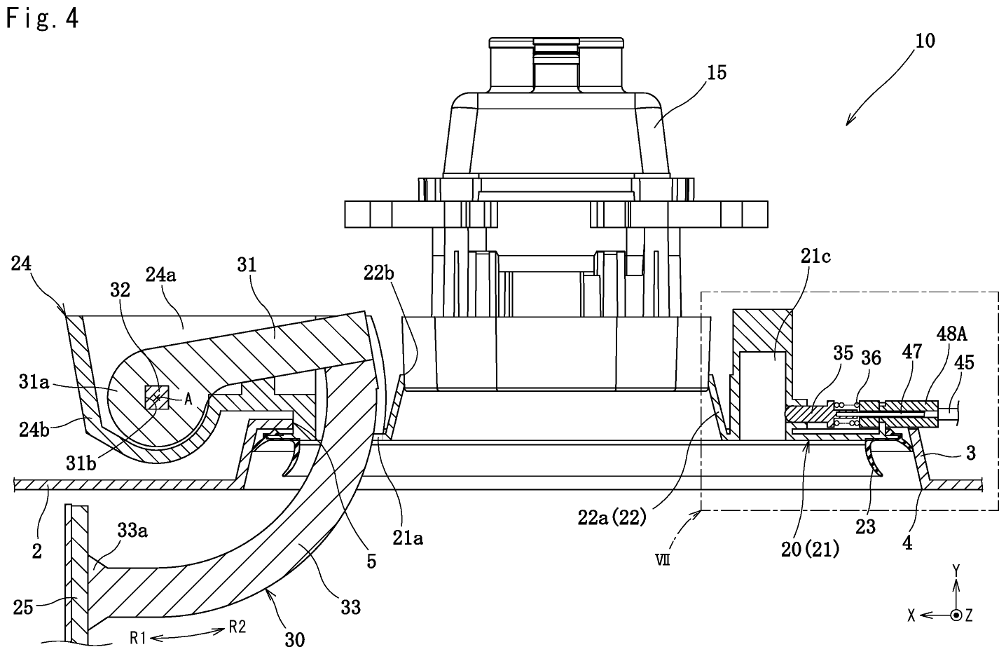

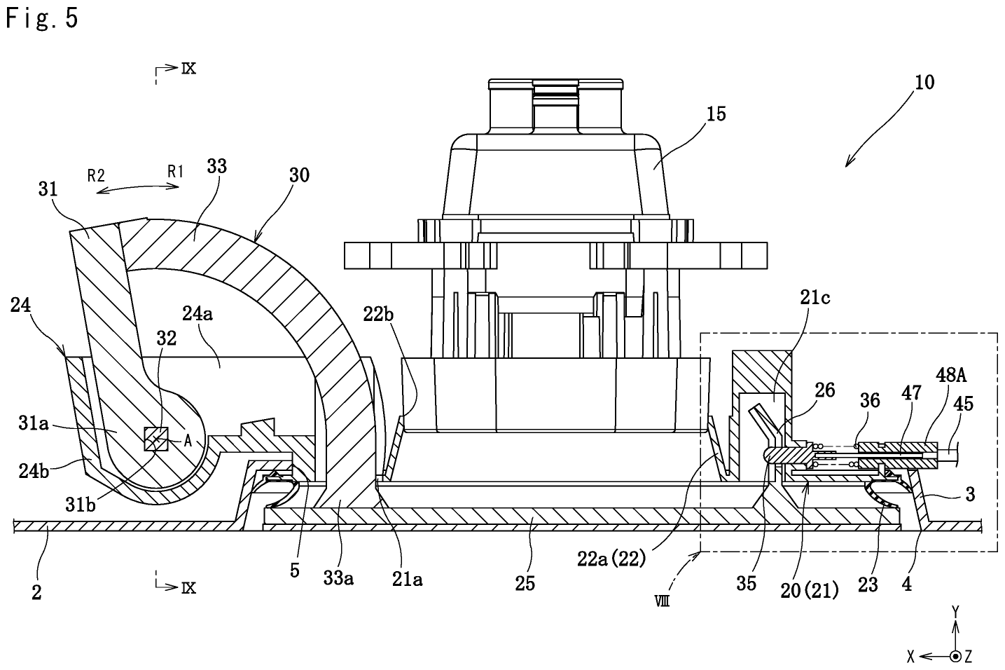

Referring to FIGS. 4 and 5, the side panel 2 is provided with a concave portion 3 recessed inward in the vehicle width direction Y. An outer end of the concave portion 3 in the vehicle width direction Y is an opening portion 4. An attachment port 5 for attaching the lid opening and closing device 10 is provided at the bottom of the concave portion 3. The shapes of the opening portion 4 and the attachment port 5 as viewed in the vehicle width direction Y are substantially elliptical in the present embodiment, but can be changed as necessary.

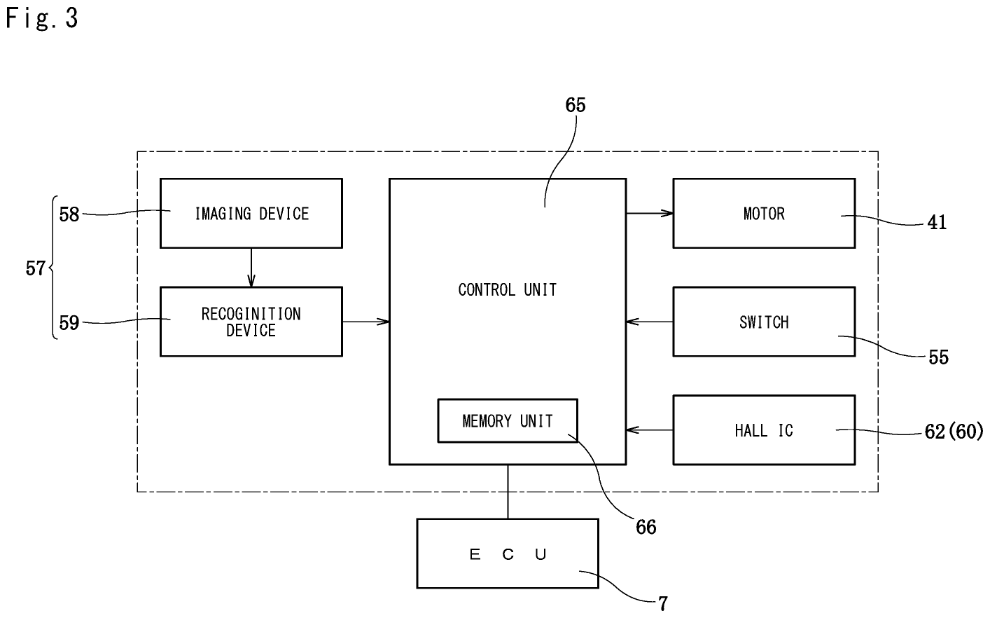

Referring to FIGS. 2 and 3, the lid opening and closing device 10 includes a base 20 attached to the side panel 2, a lid 25 that openably closes the opening portion 4, and a drive mechanism 40 including a motor 41 that opens and closes the lid 25. The lid opening and closing device 10 includes a switch (operation receiving unit) 55 that receives an operation of opening and closing the lid 25 by the drive mechanism 40, a water detection unit 57 for detecting water outside the automobile 1, and a control unit 65 that controls the drive mechanism 40.

The motor 41 included in the drive mechanism 40 rotates forward or backward in accordance with a command from the control unit 65 electrically connected via a drive circuit. The drive mechanism 40 rotates the lid 25 at a closed position shown in FIG. 5 to an open position shown in FIG. 4 by the forward rotation of the motor 41 (opening operation). The drive mechanism 40 rotates the lid 25 at the open position shown in FIG. 4 to the closed position shown in FIG. 5 by the backward rotation of the motor 41 (closing operation).

The control unit 65 is electrically connected to an electronic control unit (ECU) 7 of the automobile 1, and controls the motor 41 (drive mechanism 40) based on input states of signals from the switch 55 and the water detection unit 57. Specifically, when the opening operation is performed when there is no water outside the automobile 1, the control unit 65 executes the opening operation of the lid 25 by the drive mechanism 40. In addition, if the opening operation is erroneously performed when there is water outside the automobile 1, the control unit 65 does not execute the opening operation of the lid 25 by the drive mechanism 40. When an intentional opening operation is performed even in a state where there is water outside the automobile 1, the control unit 65 executes the opening operation of the lid 25 by the drive mechanism 40. When the closing operation is performed regardless of the presence or absence of water outside the automobile 1, the control unit 65 executes the closing operation of the lid 25 by the drive mechanism 40.

Hereinafter, the switch 55, the water detection unit 57, and the control unit 65 for automatically opening and closing the lid 25 will be specifically described with reference to FIGS. 2 and 3. The lid opening and closing device 10 of the present embodiment includes a lid detection unit 60 that detects an opened and closed state of the lid 25 as another configuration.

The switch 55 includes an operation unit 56 elastically movable forward and backward, is arranged on an inner surface side of the base 20 in the vehicle width direction Y, and is electrically connected to the control unit 65. The switch 55 is a normally open push switch in which a contact is short-circuited by operation of the operation unit 56 inward in the vehicle width direction Y. While the operation unit 56 is operated, the contact continues to be short-circuited, and thus the switch 55 continues to output the operation signal indicating that the operation has been performed. When the operation of the operation unit 56 is stopped and the electrical connection of the contacts is cut off, the switch 55 does not output the operation signal.

The operation unit 56 is arranged in a window through hole 21b of the base 20 and is operable inward in the vehicle width direction Y of the base body 21. In the open state of the lid 25 shown in FIG. 4, the operation unit 56 can be directly operated through the opening portion 4. In the closed state of the lid 25 shown in FIG. 5, the operation unit 56 can be operated by a pressing portion 27 shown in FIG. 2 by pressing the lid 25 itself inward in the vehicle width direction Y.

In the present embodiment, one switch 55 receives three different types of operations. One of them is a first operation of opening the lid 25 when the water detection unit 57 does not detect water (first operation receiving unit). The other is a second operation of opening the lid 25 regardless of the water detection state by the water detection unit 57 (second operation receiving unit). The remaining one is a third operation of closing the lid 25 regardless of the water detection state by the water detection unit 57 (third operation receiving unit). Which operation is performed is decided (determined) by the control unit 65 based on the opened and closed state of the lid 25 and the operation time of the switch 55. However, the three types of operations may be received by different switches.

Referring to FIGS. 1 and 2, the water detection unit 57 is attached to an automobile interior side of a windshield 6 of the automobile 1, and detects the presence or absence of water outside the automobile 1 through the windshield 6. The water detection unit 57 is electrically connected to the control unit 65, outputs a water detection signal (second signal) when water outside the automobile 1 is detected, and does not output the water detection signal unless the water outside the automobile 1 is detected.

Referring to FIG. 3, the water detection unit 57 of the present embodiment includes an imaging device 58 and a recognition device 59.

The imaging device 58 includes an imaging element such as a charge-coupled device (CCD) and a complementary metal-oxide semiconductor (CMOS). The imaging device 58 is arranged on the windshield 6 in a posture in which the optical axis faces the forward direction of the automobile 1, and can image the glass surface of the windshield 6 and the outside of the automobile 1 through the windshield 6. The imaging device 58 captures an image of an object present in the imaging region, and continuously generates a luminance image including at least luminance information for each frame. The main object imaged by the imaging device 58 is water adhering to the windshield 6. However, the object may be bubbles of water droplets adhering to the windshield 6.

The recognition device 59 is electrically connected to the imaging device 58, and a plurality of luminance images captured by the imaging device 58 is input thereto. The recognition device 59 recognizes water adhered to the windshield 6 on the basis of the plurality of luminance images generated by the imaging device 58 and having different imaging times, and outputs a recognition result (water detection state) to the electrically connected control unit 65.

The lid detection unit 60 detects whether or not the lid 25 is at the closed position shown in FIG. 5 or the open position shown in FIG. 4. The lid detection unit 60 includes a magnet 61 attached to the lid 25 as shown in FIG. 2, and a Hall IC 62 (see FIG. 3) arranged at a position facing the magnet 61 at the closed position shown in FIG. 5. However, the lid detection unit 60 can be applied as necessary as long as it is configured to detect the opened and closed state of the lid 25.

Referring to FIG. 3, the Hall IC 62 is electrically connected to the control unit 65, and outputs a closing detection signal (fourth signal) when detecting the magnetic field of the magnet 61. That is, the Hall IC 62 outputs the closing detection signal when the lid 25 is at the closed position, and does not output the closing detection signal when the lid 25 is at the open position.

The control unit 65 includes a single or a plurality of microcomputers and other electronic devices, and is communicably connected to the ECU 7. The control unit 65 controls the motor 41 (drive mechanism 40) on the basis of input states of signals from the switch 55, the recognition device 59, and the Hall IC 62 that are electrically connected.

Specifically, when the lid 25 is at the closed position, the control unit 65 makes a determination based on the operation time of the switch 55 and a determination based on the detection result of the water detection unit 57, and makes a determination as to whether or not to execute the opening operation of the lid 25 by the drive mechanism 40. On the other hand, when the lid 25 is at the open position, when the operation signal is input from the switch 55, the control unit 65 executes the closing operation of the lid 25 by the drive mechanism 40 regardless of the input state of the water detection signal from the water detection unit 57.

Specifically, when the operation signal is input from the switch 55, the control unit 65 checks the input state of the closing detection signal from the lid detection unit 60. Thereafter, when determining that the lid 25 is at the closed position based on the input state of the closing detection signal from the lid detection unit 60, the control unit 65 determines whether or not to execute the opening operation of the lid 25 by the drive mechanism 40 based on the input state of the signals from the switch 55 and the water detection unit 57. On the other hand, when determining that the lid 25 is at the open position based on the input state of the closing detection signal from the lid detection unit 60, the control unit 65 rotates the motor 41 backward and executes the closing operation of the lid 25 by the drive mechanism 40.

The execution determination of the opening operation of the lid 25 by the control unit 65 is performed as follows.

In the non-input state where the operation signal is input from the switch 55 and the water detection signal is not input from the water detection unit 57, the control unit 65 rotates the motor 41 forward and executes the opening operation of the lid 25 by the drive mechanism 40.

On the other hand, in the input state where the operation signal is input from the switch 55 and the water detection signal is input from the water detection unit 57, the control unit 65 further determines whether or not to execute the opening operation of the lid 25 by the drive mechanism 40 based on the input time of the continuous operation signal (that is, the operation time of the operation unit 56). A storage unit 66 included in the control unit 65 stores a set time T (for example, 5 seconds) as a threshold value. When an operation signal (first signal) less than the set time T is input from the switch 55, the control unit 65 does not execute the opening operation of the lid 25 by the drive mechanism 40. On the other hand, when an operation signal (third signal) for the set time T or longer is input from the switch 55, the control unit 65 rotates the motor 41 forward and executes the opening operation of the lid 25. That is, when the third signal different from the first signal is input, the control unit 65 executes the opening operation of the lid 25 even in the input state where the water detection signal is input from the water detection unit 57.

Next, configurations of the base 20, the lid 25, and the drive mechanism 40 will be specifically described.

The lid opening and closing device 10 of the present embodiment further includes a lock member 35 that is operated by the motor 41 included in the drive mechanism 40 to lock the lid 25 at the closed position as another configuration. The lid 25 includes an arm 30 for attaching to the base 20. Furthermore, the drive mechanism 40 includes a differential mechanism 50 for securing a time difference between the start of rotation of the arm 30 and the start of movement of the lock member 35.

Referring to FIGS. 4 to 6, the base 20 is arranged inside the opening portion 4 of the side panel 2, and includes a base body 21 that closes the attachment port 5 and a bearing portion 24 that pivotally supports the arm 30.

The base body 21 is provided with an attachment portion 22 for attaching the power supply connector 15, and a seal member 23 for sealing between the lid 25 at the closed position and the base body 21 is attached.

Referring to FIG. 5, the attachment portion 22 includes a concave portion 22a recessed inward in the vehicle width direction Y, and an attachment port 22b is formed at the bottom of the concave portion 22a. A power supply connector 15 is attached to the attachment port 22b from the inside in the vehicle width direction Y. Thus, as shown in FIG. 2, a connecting portion 15a of the power supply connector 15 is located in the opening portion 4, and is exposed to the outside of the vehicle through the opening portion 4 when the lid 25 is released.

Referring to FIGS. 4 and 5, the seal member 23 has a ring shape, is attached to the outer side of the base body 21 in the vehicle width direction Y along the outer peripheral edge of the base body 21, and protrudes from the bottom side of the concave portion 3 toward the opening portion 4. The seal member 23 is brought into pressure contact with the lid 25 at the closed position shown in FIG. 5, and seals a space between the base body 21 and the lid 25 in a watertight manner. The seal member 23 is not brought into pressure contact with the lid 25 at the open position shown in FIG. 4.

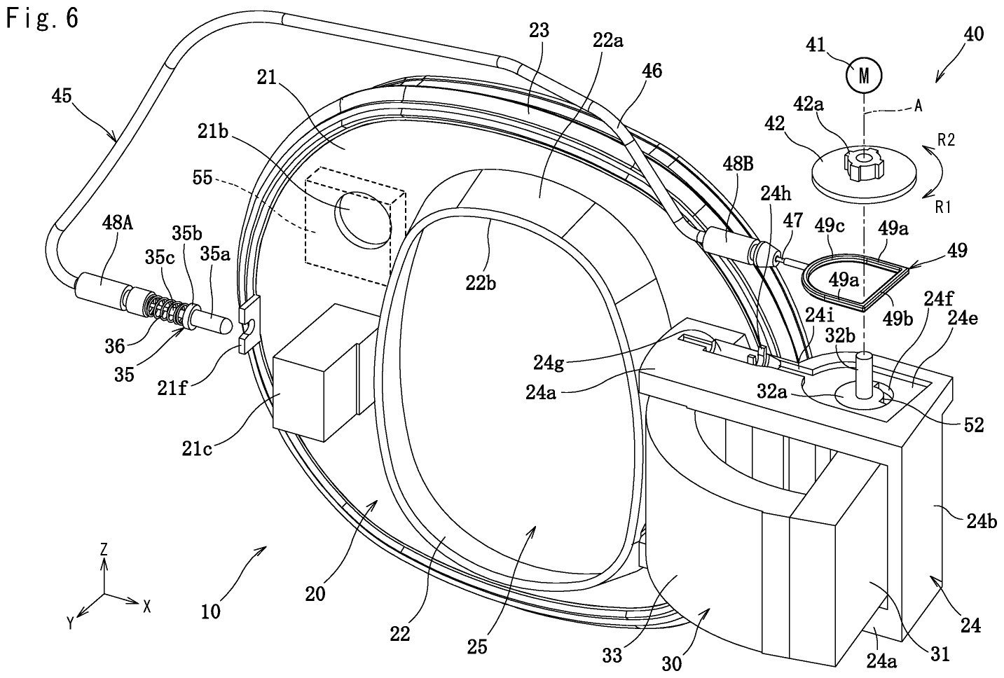

Referring to FIGS. 2 and 6, the base body 21 is provided with an insertion through hole 21a, a window through hole 21b, and a concave portion 21c so as to be located in the opening portion 4.

The insertion through hole 21a is a quadrangular hole having a long dimension in the vehicle height direction Z, and is provided so as to be located on the front side of the attachment portion 22 in the vehicle length direction X and in the bearing portion 24. The arm 30 is inserted through the insertion through hole 21a so as to be movable forward and backward.

The window through hole 21b is formed of a circular hole and is provided on the rear side in the vehicle length direction X of the attachment portion 22. In the window through hole 21b, the operation unit 56 of the switch 55 is arranged from the inside in the vehicle width direction Y of the base body 21.

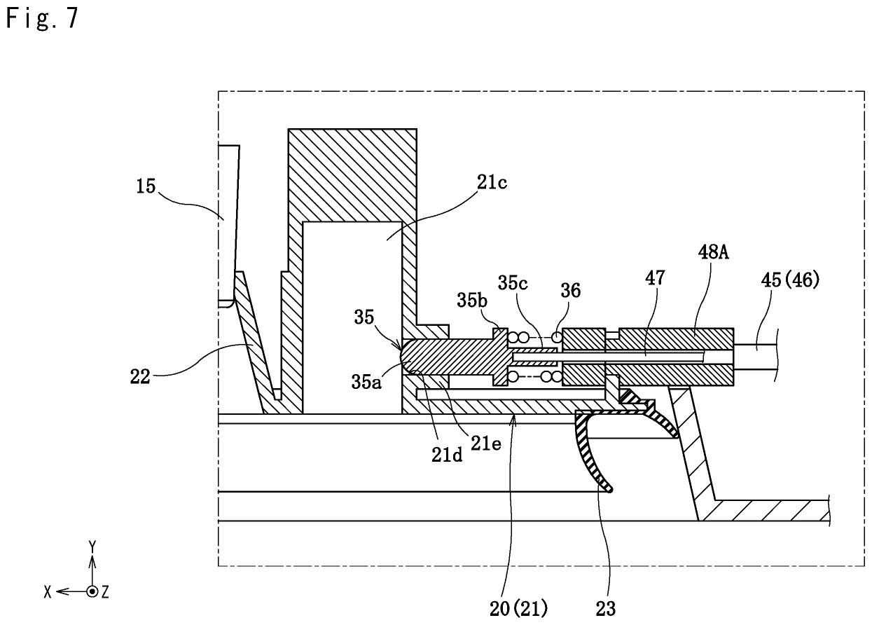

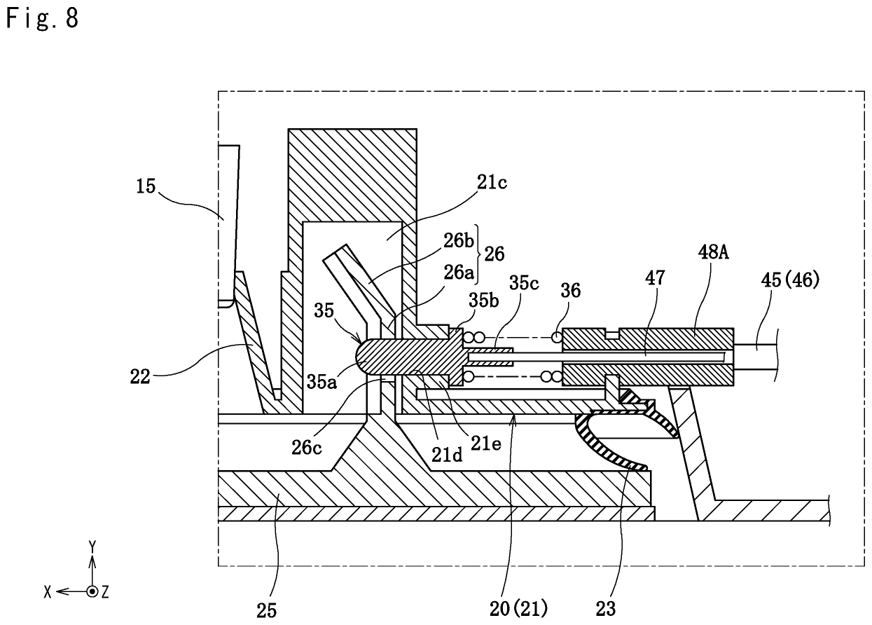

The concave portion 21c is a quadrangular recess extending inward in the vehicle width direction Y, and is provided below the window through hole 21b. Referring to FIGS. 7 and 8, a lock piece 26 described later is inserted into the concave portion 21c so as to be movable forward and backward. An insertion through hole 21d through which the lock member 35 is inserted so as to be movable forward and backward is provided in a wall defining the concave portion 21c. The insertion through hole 21d is provided in a wall located on the rear side in the vehicle length direction X. A cylindrical holding portion 21e that holds the lock member 35 is provided around the insertion through hole 21d.

Referring to FIG. 6, an attachment piece 21f to which one end of a cable 45 (described later) included in the drive mechanism 40 is attached is provided on the rear side of the concave portion 21c in the vehicle length direction in the base body 21. The Hall IC 62 (see FIG. 3) constituting the lid detection unit 60 is arranged between the window through hole 21b and the concave portion 21c.

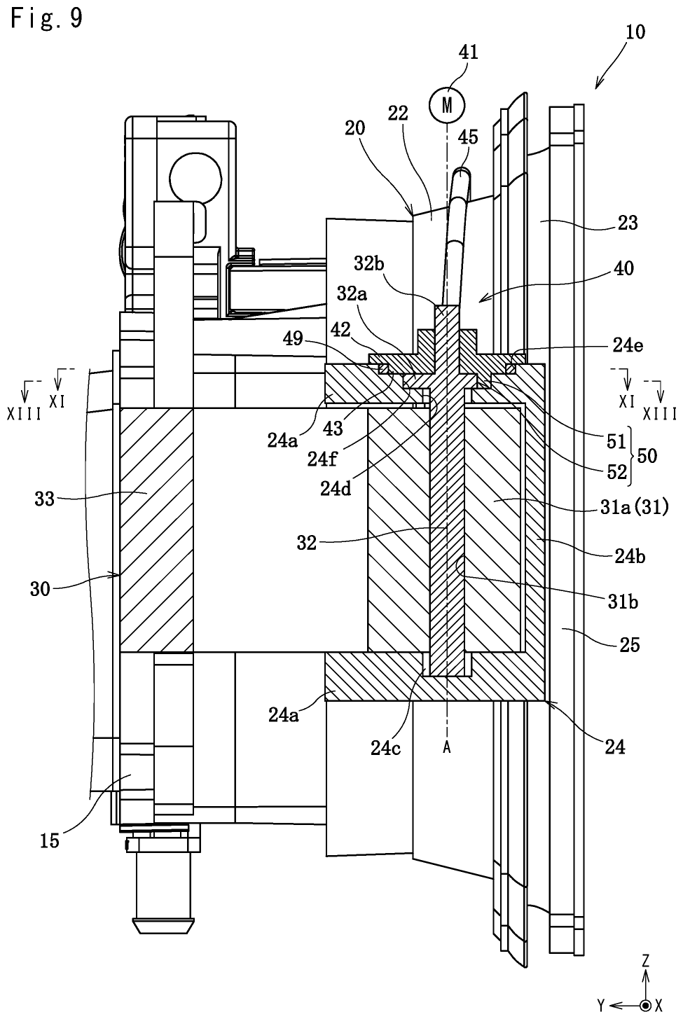

Referring to FIGS. 6 and 9, the bearing portion 24 has an integral structure with the base body 21, is adjacent to the front side of the attachment portion 22 in the vehicle length direction X, and protrudes outward from the base body 21. The bearing portion 24 includes a pair of end plates 24a and a coupling plate 24b coupling the end plates 24a. The pair of end plates 24a are provided at intervals in the vehicle height direction Z so as to be located above and below the insertion through hole 21a, and both extend along the XY plane. The coupling plate 24b is continuous with the front end in the vehicle length direction X and the outer end in the vehicle width direction Y of each of the pair of end plates 24a, and opens the other end portion of the end plate 24a.

The lower end plate 24a is provided with a shaft hole 24c, and the upper end plate 24a is provided with a shaft through hole 24d at a position facing the shaft hole 24c. The shaft hole 24c is a circular recess, and the shaft through hole 24d is a circular through hole having the same diameter as the shaft hole 24c. A center line in the vehicle height direction Z passing through the shaft hole 24c and the shaft through hole 24d is the rotation axis A.

The upper end plate 24a is further provided with a guide concave portion 24e, a holding concave portion 24f, and an attachment concave portion 24g. All of them are provided so as to be recessed downward from the upper surface side of the upper end plate 24a.

Referring to FIGS. 6, 9, and 11, the guide concave portion 24e is provided in a region including the shaft through hole 24d, and holds a cam follower 49 (described later) included in the drive mechanism 40 so as to be movable in the vehicle length direction X. When viewed in the vehicle height direction Z, the guide concave portion 24e has a semi-elliptical shape including a first portion 24e1 having a quadrangular shape and a second portion 24e2 having a semicircular shape. The second portion 24e2 is continuous with the rear side of the first portion 24e1 in the vehicle length direction X.

Referring to FIGS. 6, 9, and 13, the holding concave portion 24f is provided at the bottom of the guide concave portion 24e so as to be adjacent to the upper side of the shaft through hole 24d. The holding concave portion 24f has a circular shape having a larger diameter than the shaft through hole 24d, and spatially communicates with each of the lower shaft through hole 24d and the upper guide concave portion 24e.

Referring to FIG. 6, the attachment concave portion 24g has a semicircular cross section, and one end of the cable 45 of the drive mechanism 40 is attached thereto. The attachment concave portion 24g is provided with a holding piece 24h having a C-shaped cross section for holding the cable 45. A communication groove 24i that spatially communicates the attachment concave portion 24g and the guide concave portion 24e is provided therebetween.

Referring to FIGS. 2, 4, and 5, the lid 25 has a plate shape smaller than the opening portion 4 and larger than the seal member 23, and closes the opening portion 4 so as to be openable. When the arm 30 is pivotally supported by the bearing portion 24, the lid 25 is allowed to move between a closed position where the opening portion 4 is closed and an open position where the opening portion 4 is opened.

Referring to FIGS. 2 and 8, the lid 25 is provided with a lock piece (engaging portion) 26 to be inserted into the concave portion 21c of the base 20 when the lid 25 is rotated to the closed position shown in FIG. 5. The lock piece 26 includes a lock piece body 26a and an inclined portion 26b.

The lock piece body 26a protrudes in the orthogonal direction toward the inside in the vehicle width direction Y from the lid 25 in the closed state of the lid 25. A quadrangular lock through hole 26c with which the lock member 35 engages is formed in the lock piece body 26a.

The inclined portion 26b is continuous with the inner end of the lock piece body 26a in the vehicle width direction Y, and is inclined in a direction away from the lock member 35 from the outside to the inside in the vehicle width direction Y.

The lid 25 includes the pressing portion 27 facing the operation unit 56 (window through hole 21b) when rotated to the closed position. The pressing portion 27 protrudes from the lid 25 toward the inside in the vehicle width direction Y in the orthogonal direction. When the lid 25 at the closed position is further pressed inward in the vehicle width direction Y, the operation unit 56 is pushed by the pressing portion 27, and the switch 55 can be operated.

The magnet 61 constituting the lid detection unit 60 is arranged between the lock piece 26 and the pressing portion 27. A part of the magnet 61 may be exposed from the inner side surface of the lid 25. When the lid 25 is made of resin, the magnet 61 may be embedded in the lid 25 by insert molding.

Referring to FIGS. 2, 4, and 5, the arm 30 is arranged to straddle from the inside to the outside of the base 20 in the vehicle width direction Y through the insertion through hole 21a. The arm 30 includes a plate-shaped first arm portion 31 pivotally supported by the bearing portion 24 and an arc-shaped second arm portion 33 connected to the lid 25.

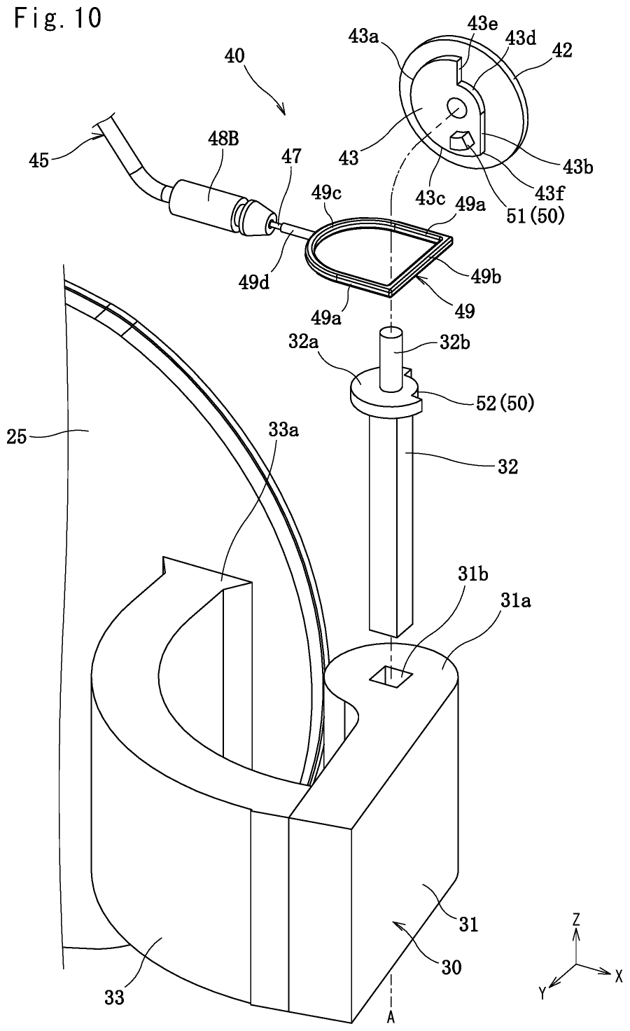

A pivot portion 31a pivotally supported by the bearing portion 24 is provided at a proximal end (one end side of the arm 30) of the first arm portion 31. That is, the first arm portion 31 protrudes outward from the pivot portion 31a. Referring to FIGS. 9 and 10, the pivot portion 31a includes an attachment through hole 31b having a square (non-circular) cross section in which the shaft member 32 is attached. The pivot portion 31a is arranged between the pair of end plates 24a of the bearing portion 24 and is rotatable about the rotation axis A via the shaft member 32.

With continued reference to FIGS. 9 and 10, the shaft member 32 is a rod body having a square cross section passing through the attachment through hole 31b of the first arm portion 31, and rotates integrally with the pivot portion 31a. That is, the shaft member 32 cannot rotate relative to the pivot portion 31a. The shaft member 32 penetrates the shaft through hole 24d from the upper side of the bearing portion 24, has a distal end arranged in the shaft hole 24c, and is rotatably supported by the inner peripheral wall of each of the shaft hole 24c and the shaft through hole 24d.

Referring to FIGS. 6 and 9, the shaft member 32 includes a flange portion 32a rotatably held in the holding concave portion 24f and a shaft portion 32b protruding upward from the flange portion 32a. The thickness of the flange portion 32a is substantially the same as the depth of the holding concave portion 24f in the vehicle height direction Z. The shaft portion 32b has an axis coinciding with the rotation axis A, and protrudes upward from the guide concave portion 24e in a state of being attached to the bearing portion 24.

Referring to FIGS. 2, 4, and 5, the second arm portion 33 is mechanically connected to a distal end of the first arm portion 31 on a side opposite to the pivot portion 31a. The second arm portion 33 has an arc shape centered on the rotation axis A. A connecting portion (distal end portion) 33a mechanically connected to the lid 25 is provided at the distal end of the second arm portion 33 (the other end side of the arm 30).

Referring to FIGS. 6 to 8, the lock member 35 is arranged in the insertion through hole 21d of the base 20 so as to be movable forward and backward. The lock member 35 is attached to a wire 47 of the cable 45, a rotational force of the rotating body 42 described later is transmitted via a cam 43 and the wire 47, and is linearly moved to a lock position shown in FIG. 8 and an unlock position shown in FIG. 7. The lock member 35 is elastically biased toward the lock position side (the front side in the vehicle length direction X, which is the lock piece 26 side) by a spring 36 having one end supported by the cable 45. Specifically, the lock member 35 includes a lock portion 35a and a flange portion 35b.

The lock portion 35a has a rod shape having a diameter smaller than that of the insertion through hole 21d, and has a hemispherical chamfered distal end. The lock portion 35a protrudes into the concave portion 21c when at the lock position, and engages with the lock through hole 26c when the lock piece 26 is in the concave portion 21c to prevent (lock) movement of the lock piece 26 outward in the vehicle width direction Y. The lock portion 35a is retracted into the holding portion 21e when at the unlock position, the engagement with the lock through hole 26c of the lock piece 26 is released, and the movement of the lock piece 26 toward the outside in the vehicle width direction Y is allowed (unlocked).

The flange portion 35b has a disk shape having a diameter larger than the diameter of each of the insertion through hole 21d and the spring 36. Referring to FIGS. 7 and 8, the flange portion 35b is located outside the holding portion 21e at either the lock position or the unlock position. When the lock member 35 moves to the lock position, the flange portion 35b abuts on the holding portion 21e and restricts further movement of the lock member 35. The flange portion 35b is provided with a cylindrical attachment portion 35c to be attached to the wire 47.

Referring to FIGS. 2 and 6, the drive mechanism 40 includes one motor 41, a rotating body 42, a cam 43, and a cable 45, and is arranged on an upper portion of the base 20. Among them, the cable 45 includes a cam follower 49 that follows the rotation of the cam 43.

The motor 41 is a drive source capable of forward rotation and backward rotation, and performs both opening and closing of the lid 25 and movement of the lock member 35. By the forward rotation, the motor 41 moves the arm 30 at the retracted position to the advanced position, operates the lid 25 at the closed position to the open position, and operates the lock member 35 at the lock position to the unlock position. By the backward rotation, the motor 41 moves the arm 30 at the advanced position to the retracted position, operates the lid 25 at the open position to the closed position, and operates the lock member 35 at the unlock position to the lock position.

The rotating body 42 has a disk shape and is arranged on the bearing portion 24 side of the base 20. The rotating body 42 transmits the drive force received from the motor 41 to the pivot portion 31a to rotate the arm 30, and transmits the drive force to the lock member 35 to move the lock member 35. Specifically, the rotating body 42 includes an attachment portion 42a attached to the motor 41, and is directly rotated by the motor 41. Referring to FIG. 6, the rotating body 42 rotates in the direction indicated by R1 when the motor 41 rotates forward to open the lid 25, and rotates in the direction indicated by R2 when the motor 41 rotates backward to close the lid 25.

Referring to FIGS. 9 and 10, the rotating body 42 is arranged on the guide concave portion 24e of the base 20 so as to be coaxial with the pivot portion 31a of the arm 30. That is, the rotation axis of the rotating body 42, the rotation axis A of the pivot portion 31a, and the axis of the bearing portion 24 all coincide with each other. The rotating body 42 is coupled to the pivot portion 31a via a differential mechanism 50. As a result, as shown in FIGS. 4 and 5, the pivot portion 31a (arm 30) rotates in the same directions R1 and R2 as the rotating body 42 in conjunction with the rotation of the rotating body 42.

Referring to FIGS. 9 and 10, the cam 43 has an integral structure with the rotating body 42, and rotates in the directions R1 and R2 in conjunction with the rotating body 42. Specifically, the cam 43 protrudes from the lower surface of the rotating body 42 facing the pivot portion 31a, and is arranged in the guide concave portion 24e of the base 20 so as to be adjacent to the pivot portion 31a. The protruding amount of the cam 43 in the vehicle height direction Z is the same as the depth of the guide concave portion 24e.

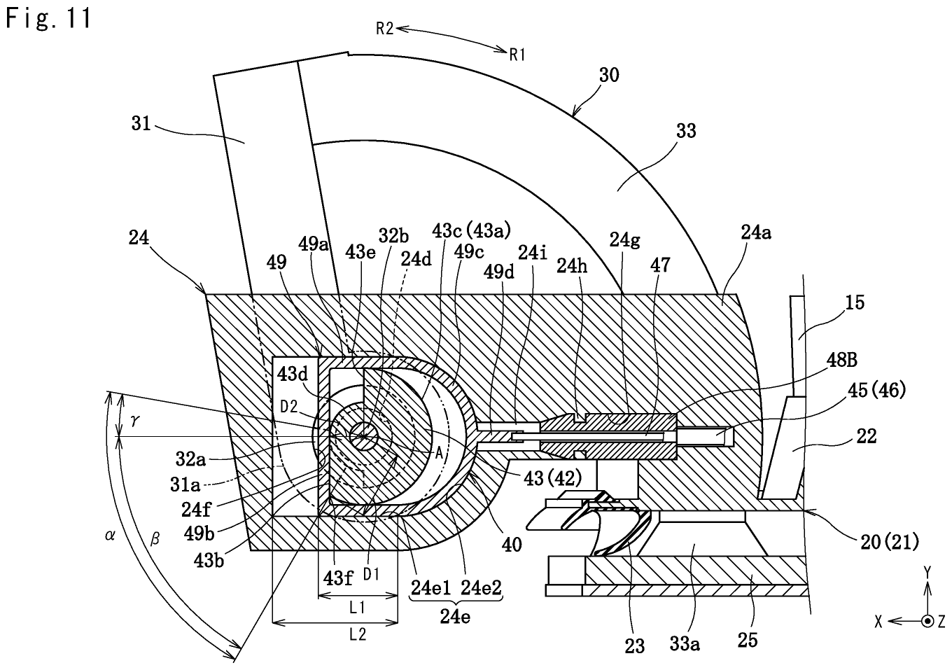

Referring to FIGS. 10 and 11, the cam 43 includes a rotation axis coinciding with the rotation axis A and a non-circular outer peripheral portion 43a. That is, the cam 43 and the pivot portion 31a have the same rotation axis A. The outer peripheral portion 43a includes a first straight portion 43b, a first arcuate portion 43c, a second arcuate portion 43d, and a second straight portion 43e.

The first straight portion 43b transmits the rotational force of the rotating body 42 to the lock member 35 via the cable 45 to move the lock member 35 to the lock position and the unlock position. Specifically, the first straight portion 43b linearly extends between a position at a distance D1 from the rotation axis A and a position at a distance D2 from the rotation axis A. The angular position around the rotation axis A is different between one end on the distance D1 side and the other end on the distance D2 side. The distance D2 is shorter than the distance D1, and the dimensional difference (D1-D2) between the distances D1 and D2 corresponds to the movement stroke of the lock member 35. That is, an angular range β from one end to the other end of the first straight portion 43b corresponds to the rotational angle of the cam 43 for moving the lock member 35 to the lock position and the unlock position.

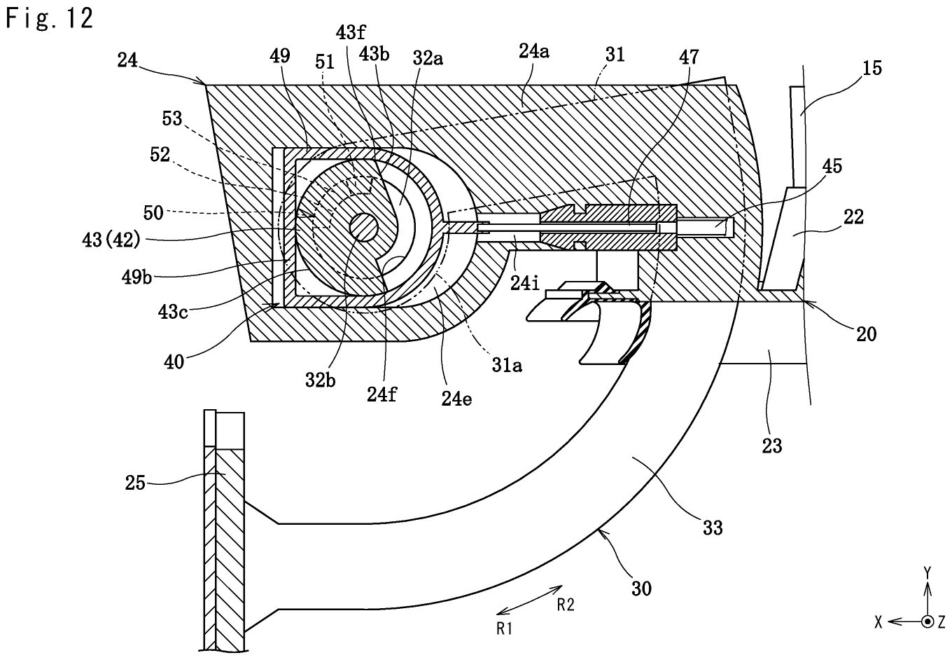

One end of the first straight portion 43b on the distance D1 side constitutes a pressing portion 43f that presses the cam follower 49. When the cam 43 rotates in the direction R1 at the time of a lid opening operation, the pressing portion 43f moves from the position shown in FIG. 11 to the front side in the vehicle length direction X, which is the left side, and presses and moves the cam follower 49 in the same direction (see FIG. 12). When the cam 43 rotates in the direction R2 at the time of a lid closing operation, the pressing portion 43f moves from the position shown in FIG. 12 to the rear side in the vehicle length direction X, which is the right side, and allows the movement of the cam follower 49 in the same direction (see FIG. 11).

Referring to FIGS. 10 and 12, the first arcuate portion 43c holds the lock member 35 at the unlock position via the cable 45. The first arcuate portion 43c has an arc shape centered on the rotation axis A, and is continuous with the pressing portion 43f of the first straight portion 43b. The radius of the first arcuate portion 43c is the same dimension as the distance D1 of the pressing portion 43f. The angular range for forming the first arcuate portion 43c is preferably 180 degrees or more, and is 210 degrees in the present embodiment.

Referring to FIGS. 10 and 11, the second arcuate portion 43d holds the lock member 35 at the lock position via the cable 45. The second arcuate portion 43d has an arc shape centered on the rotation axis A, and is continuous with an end portion of the first straight portion 43b on the distance D2 side. The radius of the second arcuate portion 43d is the same dimension as the distance D2.

The second straight portion 43e is not involved in the movement of the lock member 35 via the cable 45. The second straight portion 43e is continuous with an end portion of the first arcuate portion 43c not continuous with the first straight portion 43b and an end portion of the second arcuate portion 43d not continuous with the first straight portion 43b, and extends in the radial direction of the first arcuate portion 43c. That is, the angular position around the rotation axis A is the same at the inner end and the outer end of the second straight portion 43e.

Referring to FIG. 6, the cable 45 is a transmission member that transmits the rotational force of the cam 43 to the lock member 35 to move, and includes a tube 46 having flexibility, a wire 47 movable forward and backward in the tube 46, and a cam follower 49. The lock member 35 is attached to a rear end of the wire 47 in the vehicle length direction X opposite to the bearing portion 24, and the cam follower 49 is attached to a front end of the wire 47 in the vehicle length direction X on the bearing portion 24 side.

A cable end 48A is attached to an end portion of the tube 46 on the lock member 35 side, and a cable end 48B is attached to an end portion of the tube 46 on the cam follower 49 side. The cable end 48A is attached to the attachment piece 21f of the base 20, and the cable end 48B is attached to the attachment concave portion 24g of the base 20. Referring to FIGS. 7 and 8, the spring 36 is arranged in a compressed state between the cable end 48A and the lock member 35.

Referring to FIGS. 6, 10, and 11, the cam follower 49 has an annular shape surrounding the outer peripheral portion 43a of the cam 43, and is arranged in the guide concave portion 24e of the base 20. The rotation of the cam 43 allows the cam follower 49 to move between a first operating position where the cam follower 49 moves to the front side in the vehicle length direction X in the guide concave portion 24e as shown in FIG. 12 and a second operating position where the cam follower 49 moves to the rear side in the vehicle length direction X in the guide concave portion 24e as shown in FIG. 11.

The thickness of the cam follower 49 in the vehicle height direction Z is substantially equal to the protruding amount of the cam 43 and the depth of the guide concave portion 24e. The cam follower 49 has a semi-elliptical shape as viewed in the vehicle height direction Z, and includes a pair of side portions 49a, a press receiving portion 49b, an arcuate portion 49c, and an attachment portion 49d.

Each of the pair of side portions 49a extends linearly in the vehicle length direction X and is arranged adjacent to a pair of side walls extending in the vehicle length direction X in the first portion 24e1 of the guide concave portion 24e. A length L1 of the side portion 49a in the vehicle length direction X is shorter than the length L2 of the first portion 24e1 of the guide concave portion 24e in the vehicle length direction X. A dimensional difference (L2-L1) between the length L1 of the side portion 49a and the length L2 of the first portion 24e1 is larger than a dimensional difference (D1-D2) between the distances D1 and D2 of the first straight portion 43b, that is, a movement stroke of the lock member 35 between the lock position and the unlock position.

The press receiving portion 49b is continuous with each of the front ends of the pair of side portions 49a in the vehicle length direction X and linearly extends in the vehicle width direction Y.

The arcuate portion 49c is continuous with each of the rear ends of the pair of side portions 49a in the vehicle length direction X and has a semicircular arc shape protruding to the rear side in the vehicle length direction X. The arcuate portion 49c has a curvature along the inner wall of the second portion 24e2 of the guide concave portion 24e, and functions as a stopper that prevents further movement of the cam follower 49 toward the rear side in the vehicle length direction X by abutting on the second portion 24e2.

The attachment portion 49d is provided at a top portion of the arcuate portion 49c on the rear side in the vehicle length direction X, and is attached to an end portion of the wire 47. In the first operating position shown in FIG. 12, a part of the attachment portion 49d is located in the communication groove 24i of the base 20. In the second operating position shown in FIG. 11, the entire attachment portion 49d is located in the communication groove 24i of the base 20.

When the lid 25 in the closed state shown in FIG. 5 is operated to open and the cam 43 rotates in the direction R1, the press receiving portion 49b is pressed by the pressing portion 43f, and the cam follower 49 moves from the second operation position shown in FIG. 11 to the first operation position shown in FIG. 12. As a result, the wire 47 moves in conjunction, and the lock member 35 at the lock position shown in FIG. 8 moves to the unlock position shown in FIG. 7.

When the lid 25 in the open state shown in FIG. 4 is operated to close and the cam 43 rotates in the direction R2, the pressing portion 43f shown in FIG. 12 moves to the front side in the vehicle length direction X and then gradually moves to the rear side (see FIG. 11). When moving to the rear side in the vehicle length direction X, the holding position of the press receiving portion 49b by the pressing portion 43f is displaced, and thus, the lock member 35 biased by the spring 36 moves from the unlock position shown in FIG. 7 toward the lock position shown in FIG. 8, and the wire 47 also moves in conjunction therewith. As a result, the cam follower 49 moves from the first operation position shown in FIG. 12 toward the second operation position shown in FIG. 11 following the movement of the pressing portion 43f.

Referring to FIGS. 9 and 10, the differential mechanism 50 is provided on the rotating body 42 and the pivot portion 31a of the arm 30, and starts the rotation of the pivot portion 31a with a delay after the rotation of the rotating body 42 starts. Specifically, the differential mechanism 50 includes a convex portion 51 provided on the rotating body 42 and a concave portion 52 provided on the shaft member 32 (pivot portion 31a). However, the convex portion 51 may be provided on the shaft member 32, and the concave portion 52 may be provided on the rotating body 42.

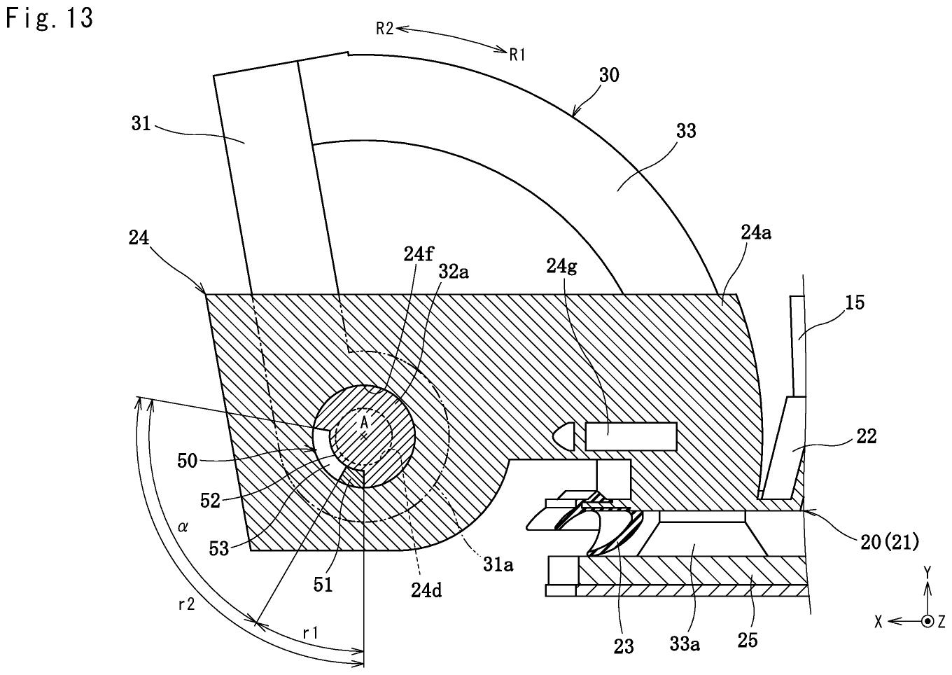

The convex portion 51 is provided to protrude from a lower surface of the cam 43 integrally molded with the rotating body 42. Referring to FIG. 13, the convex portion 51 has a fan shape when viewed from the vehicle height direction Z, and is provided at an interval radially outward with respect to the rotation axis A.

Referring to FIGS. 10 and 13, the concave portion 52 is provided in the flange portion 32a of the shaft member 32 included in the pivot portion 31a, and is formed of a notch recessed in the radial direction. The concave portion 52 has a fan shape larger than the convex portion 51 when viewed from the vehicle height direction Z, and the convex portion 51 is arranged inside.

An angular range r1 of the convex portion 51 around the rotation axis A is smaller than an angular range r2 of the concave portion 52 around the rotation axis A. As a result, a gap 53 of a difference between the angular ranges r1 and r2 is formed between the convex portion 51 and the concave portion 52 in the circumferential direction around the rotation axis A. The rotation of the rotating body 42 causes the opposing surfaces of the convex portion 51 and the concave portion 52 in the circumferential direction to abut and press, thereby rotating the pivot portion 31a. An angular range (r2-r1) of the gap 53 is a differential angular range α in which the shaft member 32 (pivot portion 31a) is rotated by being delayed after the rotation of the rotating body 42 is started.

Referring to FIG. 11, the differential angular range α is larger than the angular range β of the first straight portion 43b of the cam 43. As a result, after the lock member 35 at the lock position moves to the unlock position, the opposing surfaces of the convex portion 51 and the concave portion 52 abut on each other, and the rotational force of the rotating body 42 can be transmitted to the pivot portion 31a. A difference (α-β) between the differential angular range α and the angular range β is a delay angular range γ in which the rotation of the pivot portion 31a (arm 30) is started after the movement of the lock member 35 is completed.

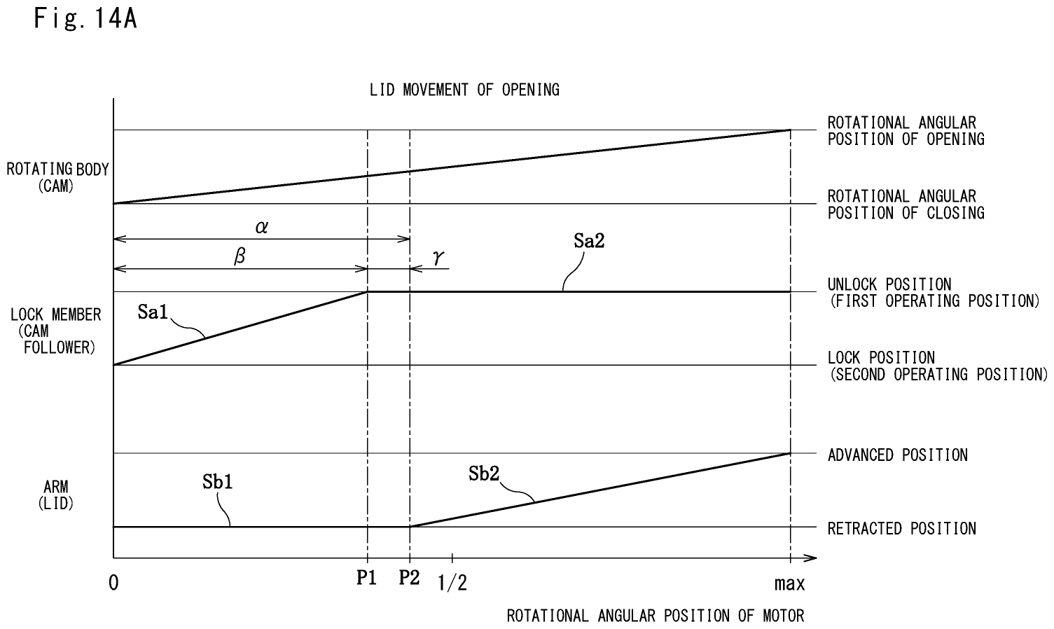

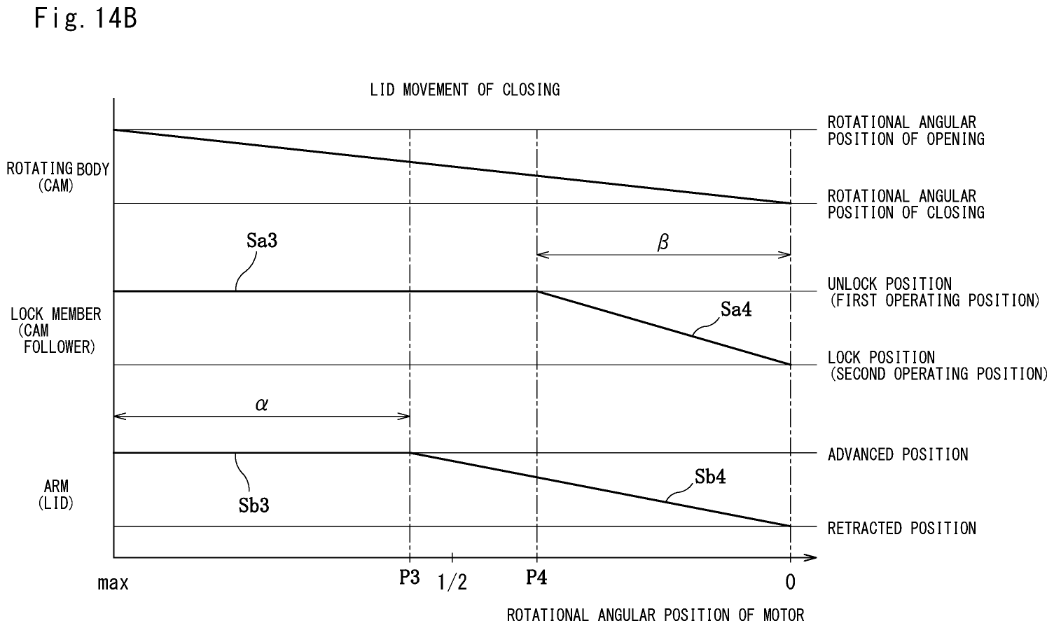

FIGS. 14A and 14B are graphs showing the movements of the arm 30 and the lock member 35 according to the rotational angular position of the motor 41 (rotating body 42). FIG. 14A shows a time of lid opening operation of rotating the lid 25 at the closed position to the open position, and FIG. 14B shows a time of a lid closing operation of rotating the lid 25 at the open position to the closed position.

The angular ranges α, β, and γ shown in FIG. 11 are set so that the lid opening operation shown in FIG. 14A is established.

Specifically, referring to FIG. 14A, the motor 41 rotates forward from an initial rotational angular position (0) toward a maximum rotational angular position (max) during the opening operation of the lid 25. As a result, the rotating body 42 starts to rotate in the direction R1 from the closed rotational angular position toward the open rotational angular position. Since the cam 43 also starts to rotate in the direction R1 together with the rotating body 42, the cam follower 49 starts to move from the second operation position shown in FIG. 11 toward the first operation position shown in FIG. 12. As a result, since the wire 47 is pulled, the lock member 35 at the lock position starts to move to the unlock position as indicated by Sa1 in FIG. 14A. At this time, since the rotational force of the rotating body 42 is not transmitted to the pivot portion 31a due to the presence of the gap 53 of the differential mechanism 50, the arm 30 does not rotate as indicated by Sb1 in FIG. 14A. Note that the above-described closed rotational angular position means the posture of the rotating body 42 in a state where the arm 30 is moved to the retracted position as shown in FIG. 5, and the open rotational angular position means the posture of the rotating body 42 in a state where the arm 30 is moved to the advanced position as shown in FIG. 4.

Subsequently, when the motor 41 rotates beyond the angular position indicated by P1 in FIG. 14A, the rotating body 42 rotates from the closed rotational angular position by an angle corresponding to the angular range β of the first straight portion 43b of the cam 43 or more. As a result, the cam follower 49 moves from the second operation position to the first operation position, and shifts from a state of being pressed by the pressing portion 43f of the cam 43 to a state of being held by the first arcuate portion 43c. Therefore, the lock member 35 is held at the unlock position (see Sa2 in FIG. 14A).

Subsequently, when the motor 41 rotates beyond the angular position indicated by P2 in FIG. 14A, the rotating body 42 rotates from the closed rotational angular position by an angle corresponding to the differential angular range α or more. Therefore, the rotational force of the rotating body 42 is transmitted to the pivot portion 31a via the differential mechanism 50, and the arm 30 at the retracted position starts to move toward the advanced position (see Sb2 in FIG. 14A).

Thereafter, when the motor 41 rotates to the maximum rotational angular position (max), the rotating body 42 rotates to the open rotational angular position. As a result, the arm 30 rotates to the advanced position shown in FIG. 4, and the lid 25 opens the opening portion 4. Further, the lock member 35 continues to be held at the unlock position by the first arcuate portion 43c of the cam 43 (see FIG. 7).

Referring to FIG. 14B, at the time of the closing operation of the lid 25, the motor 41 rotates backward from the maximum rotational angular position (max) toward the initial rotational angular position (0). As a result, the rotating body 42 starts to rotate from the open rotational angular position toward the closed rotational angular position. The cam 43 also starts to rotate in the direction R2 integrally with the rotating body 42, but since the cam follower 49 is held by the first arcuate portion 43c of the cam 43, the lock member 35 is also held at the unlock position as indicated by Sa3 in FIG. 14B (see FIG. 7). In addition, since the rotational force is not transmitted to the pivot portion 31a due to the presence of the gap 53 of the differential mechanism 50, the arm 30 also does not rotate as indicated by Sb3 in FIG. 14B.

Subsequently, when the motor 41 rotates beyond the angular position indicated by P3 in FIG. 14B, the rotating body 42 rotates from the open rotational angular position by an angle corresponding to the differential angular range α or more. As a result, the rotational force of the rotating body 42 is transmitted to the pivot portion 31a, and the arm 30 at the advanced position starts to move toward the retracted position (see Sb4 in FIG. 14B). At this time, since the cam follower 49 is held by the first arcuate portion 43c of the cam 43, the lock member 35 is also held at the unlock position (see Sa3 in FIG. 14B).

Subsequently, when the motor 41 rotates beyond the angular position indicated by P4 in FIG. 14B, the cam follower 49 is shifted from the state of being held by the first arcuate portion 43c of the cam 43 to the state of being held by the first straight portion 43b. The position where the cam follower 49 is held by the first straight portion 43b is displaced rearward in the vehicle length direction X according to the rotation of the cam 43. Therefore, as indicated by Sa4 in FIG. 14B, the lock member 35 at the unlock position starts to move toward the lock position by the biasing force of the spring 36. As a result, the cam follower 49 also starts to move from the first operating position toward the second operating position via the wire 47.

Thereafter, when the motor 41 rotates to the initial position shown in FIG. 14B, the arm 30 moves to the retracted position via the differential mechanism 50 by the rotation of the rotating body 42, and the lid 25 closes the opening portion 4 (see FIG. 5). In addition, the lock member 35 moved to the lock position via the cam follower 49 and the wire 47 by the rotation of the cam 43 engages with the lock piece 26 of the lid 25 (see FIG. 8).

Here, the timing of completing the movement of the lid 25 to the closed position and the timing of completing the movement of the lock member 35 to the lock position may be the same or either may precede. When the timings are the same or the lid 25 precedes the lock member 35, the lock portion 35a enters and engages with the lock through hole 26c located on the front side in the moving direction of the lock member 35. When the lock member 35 proceeds the lid 25, the inclined portion 26b of the lock piece 26 presses the lock portion 35a at the lock position to retract the lock member 35 to the unlock position side, and after the movement of the lid 25 is completed, the lock portion 35a can engage with the lock through hole 26c by moving to the lock position of the lock member 35 by the biasing force of the spring 36.

As described above, by setting the angular ranges α, β, and γ so that the lid opening operation shown in FIG. 14A is established, the locking and unlocking of the lid 25 by the lock member 35 can be realized without hindering the movement of the arm 30 between the advanced position shown in FIG. 4 and the retracted position shown in FIG. 5 by one motor 41.

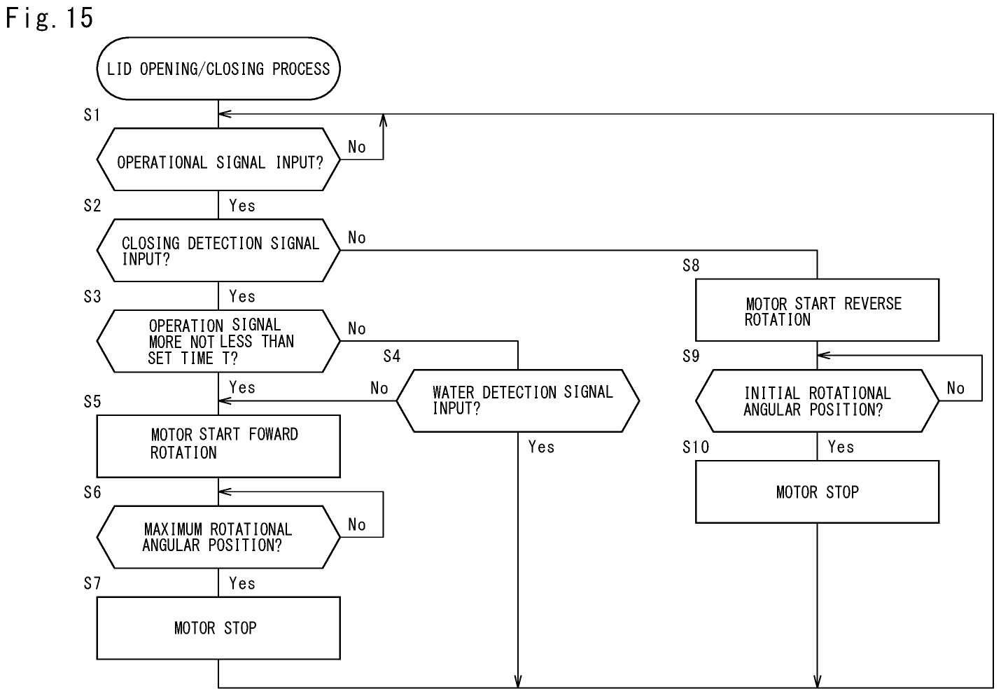

Next, an example of opening and closing processing of the lid 25 by the control unit 65 will be described with reference to FIG. 15.

The lid opening and closing processing shown in FIG. 15 is executed by the control unit 65 when the engine of the automobile 1 is stopped.

First, in step S1, the control unit 65 waits until an operation signal is input from the switch 55. When the operation signal is input, in step S2, it is confirmed whether or not the closing detection signal is input from the lid detection unit 60. When the closing detection signal is input, that is, when the lid 25 is at the closed position, the processes of steps S3 to S7 are executed, and when the closing detection signal is not input, that is, when the lid 25 is at the open position, the processes of steps S8 to S10 are executed.

In step S3, it is confirmed whether the input time of the operation signal from the switch 55 is equal to or longer than the set time T. When the input time is less than the set time T, that is, when the first signal is input from the switch 55, the processing proceeds to step S4, and when the input time is equal to or longer than the set time T, that is, when the third signal is input from the switch 55, the processing proceeds to step S5.

In step S4, it is confirmed whether or not a water detection signal is input from the water detection unit 57. When the water detection signal is input, the processing returns to step S1 without executing steps S5 to S7. On the other hand, when the water detection signal is not input, the processing proceeds to step S5.

In step S5, the forward rotation of the motor 41 is started, and the lid 25 is opened. Subsequently, in step S6, the processing waits until the motor 41 rotates to the maximum rotational angular position (see FIG. 14A). When the motor 41 rotates to the maximum rotational angular position, the motor 41 is stopped in step S7, and the processing returns to step S1.

When it is determined in step S2 that the lid 25 is at the open position, the backward rotation of the motor 41 is started and the lid 25 is closed in step S8. Subsequently, in step S9, the processing waits until the motor 41 rotates to the initial rotational angular position (see FIG. 14B). When the motor 41 rotates to the initial rotational angular position, the motor 41 is stopped in step S10, and the processing returns to step S1. That is, the lid closing operation in steps S8 to S10 are executed regardless of which of the first signal and the third signal is input from the switch 55 and the input state of the second signal from the water detection unit 57.

The lid opening and closing device 10 configured as described above has the following features.

When the first signal is input from the switch 55 while the second signal from the water detection unit 57 is in the non-input state, the control unit 65 executes the opening operation of the lid 25 by the drive mechanism 40. That is, when a user performs the opening operation when there is no water outside the automobile 1, the lid 25 can be automatically opened by the drive mechanism 40. Therefore, the convenience at the time of refueling the automobile 1 can be improved.

When the second signal from the water detection unit 57 is in the input state, the control unit 65 does not execute the opening operation of the lid 25 by the drive mechanism 40 even if the first signal is received from the switch 55. That is, even if the opening operation is erroneously performed when there is water outside the automobile 1, the lid 25 is not opened by the drive mechanism 40. Therefore, erroneous opening of the lid 25 can be prevented, and unintended infiltration of water into the lid 25 can be prevented.

Regardless of the input state of the second signal from the water detection unit 57, when the third signal is input from the switch 55, the control unit 65 executes the opening operation of the lid 25 by the drive mechanism 40. That is, even in a state where there is water outside the automobile 1, when the user performs the opening operation of forcibly opening the lid 25, the lid 25 can be automatically opened by the drive mechanism 40. As described above, since the user can automatically open the lid 25 intentionally, the convenience when refueling is performed in rainy weather or after car washing can be improved.

The drive mechanism 40 includes the rotating body 42 that transmits the drive force of the motor 41 to the pivot portion 31a of the arm 30 included in the lid 25 to open and close the lid 25, so that the lid 25 can be reliably automatically opened and closed. In addition, since the drive mechanism 40 includes the cam 43 that rotates in conjunction with the rotating body 42, the cable 45 movable by the cam 43, and the lock member 35 that locks the lid 25 by transmitting the rotational force of the rotating body 42 through the cam 43 and the cable 45, the lid 25 at the closed position can be locked in an unreleasable manner. As described above, since the automatic opening and closing and the locking of the lid 25 can be realized by one motor 41, security can be improved while suppressing an increase in size and cost of the lid opening and closing device 10 as compared with the case of mounting two motors 41.

The differential mechanism 50 has a convex portion 51 provided on one of the pivot portion 31a and the rotating body 42 and a concave portion 52 provided on the other, and has a gap 53 of a determined differential angular range α between the convex portion 51 and the concave portion 52 in the circumferential direction. Therefore, the automatic opening and closing and the locking of the lid 25 can be realized by one motor 41 without hindering the opening and closing of the lid 25 by the lock member 35.

Note that the present invention is not limited to the configuration of the above embodiment, and various modifications can be made.

For example, the lid opening and closing processing by the control unit 65 can be changed as necessary as long as it is a configuration capable of executing and not executing the opening operation of the lid 25 and executing the closing operation of the lid 25 based on the input state of the signals from the switch 55 and the water detection unit 57.

The function of forcibly opening the lid 25 (long pressing of the switch 55) in the input state of the water detection signal (second signal) from the water detection unit 57 may not be provided.

When the water detection signal (second signal) from the water detection unit 57 is in the input state, the closing operation of the lid 25 by the drive mechanism 40 may not be executed even if the operation signal (first signal) is input by the operation of the switch 55.

The switch 55 may be provided on an electronic key carried by the user, or may be provided on the automobile 1 itself. In addition, the first operation receiving unit, the second operation receiving unit, and the third operation receiving unit may be human body detection sensors using capacitance sensors, and may be configured to output an operation signal when the approach of a finger is detected.

When two or more distance measuring sensors are used as the operation receiving units and a predetermined movement (operation of opening and closing the lid 25) by the user is detected, the lid 25 may be opened or closed by the drive mechanism 40. That is, the first operation receiving unit, the second operation receiving unit, and the third operation receiving unit may have any configuration as long as the first operation receiving unit, the second operation receiving unit, and the third operation receiving unit can detect the opening operation or the closing operation of the user and output a signal. The first operation receiving unit, the second operation receiving unit, and the third operation receiving unit may be different switches, sensors, or the like.

The opening operation of forcibly opening the lid 25 even in a state where there is water outside the automobile 1 is a movement of performing the operation of the switch 55 a plurality of times within a predetermined time T, and when an operation signal is input a plurality of times within the predetermined time T, the lid 25 may be forcibly opened using this as the third signal.

The water detection unit 57 may have any configuration as long as it can detect water outside the automobile 1 and output a signal.

The lid detection unit 60 may have any configuration as long as it can detect the opened and closed state of the lid 25 and output a signal.

The lid 25 (arm 30) may be rotatable in the vertical direction about a rotation axis extending in the vehicle length direction X. The lid 25 may be configured to open and close the opening portion 4 by sliding along the side panel 2.

The differential mechanism 50 can be changed as necessary as long as it has a configuration (structure) capable of starting the rotation of the pivot portion 31a (arm 30) after moving the lock member 35 at the lock position to the unlock position.

The rotating body 42 and the cam 43 may be formed separately, and the cam 43 may rotate in conjunction with the rotating body 42 via a transmission member such as a gear.

The transmission member movable by the cam 43 may be a rod. In this case, the lock member 35 is arranged on the left side of the concave portion 21c of the base 20 shown in FIG. 7. Alternatively, the right side in FIG. 11 is set as the first operation position, the left side is set as the second operation position, and the direction in which the cam follower 49 is moved by the cam 43 is the left-right opposite direction in FIGS. 11 and 12.

As long as the cam follower 49 can follow the rotation of the cam 43, the cam follower 49 may have a shape other than the semi-elliptical shape or a shape other than the annular shape, and can be changed as necessary.

### REFERENCE SIGNS LIST

1 automobile
2 side panel (panel)
3 concave portion
4 opening portion
5 attachment port
6 windshield
7 ECU
10 lid opening and closing device
15 power supply connector (receiving portion)
15a connecting portion
20 base
21 base body
21a insertion through hole
21b window through hole
21c concave portion
21d insertion through hole
21e holding portion
21f attachment piece
22 attachment portion
22a concave portion
22b attachment port
23 seal member
24 bearing portion
24a end plate
24b coupling plate
24c shaft hole
24d shaft through hole
24e guide concave portion
24e1 first portion
24e2 second portion
24f holding concave portion
24g attachment concave portion
24h holding piece
24i communication groove
25 lid
26 lock piece (engaging portion)
26a lock piece body
26b inclined portion
26c lock through hole
27 pressing portion
30 arm
31 first arm portion
31a pivot portion
31b attachment through hole
32 shaft member
32a flange portion
32b shaft portion
33 second arm portion
33a connecting portion (distal end portion)
35 lock member
35a lock portion
35b flange portion
35c attachment portion
36 spring (biasing member)
40 drive mechanism
41 motor (drive source)
42 rotating body
42a attachment portion
43 cam
43a outer peripheral portion
43b first straight portion
43c first arcuate portion
43d second arcuate portion
43e second straight portion
43f pressing portion
45 cable (transmission member)
46 tube
47 wire (transmission member)
48A, 48B cable end
49 cam follower
49a side portion
49b press receiving portion
49c arcuate portion
49d attachment portion
50 differential mechanism
51 convex portion
52 concave portion
53 gap
55 switch (first operation receiving unit, second operation receiving unit)
56 operation unit
57 water detection unit
58 imaging device
59 recognition device
60 lid detection unit
61 magnet
62 Hall IC
65 control unit
66 storage unit

1. A lid opening and closing device comprising:
a base arranged inside an opening portion of a panel and to which a receiving portion is attached so as to be located in the opening portion;
a lid attached to the base so as to allow movement between a closed position where the opening portion is closed and an open position where the opening portion is opened;
a drive mechanism including a drive source capable of executing an opening operation of moving the lid at the closed position to the open position;
a first operation receiving unit that receives an opening operation for causing the lid to perform the opening operation and outputs a first signal;
a water detection unit that outputs a second signal when detecting water outside the vehicle; and
a control unit that controls the drive mechanism based on input states of the first signal and the second signal,
wherein the control unit executes the opening operation of the lid by the drive mechanism when the first signal is input while the second signal is in a non-input state, and does not execute the opening operation of the lid by the drive mechanism even when the first signal is input while the second signal is in an input state.

2. The lid opening and closing device according to claim 1, further comprising a second operation receiving unit that receives an opening operation for causing the lid to perform the opening operation and outputs a third signal,
wherein the control unit executes the opening operation of the lid by the drive mechanism when the third signal is input regardless of an input state of the second signal.

3. The lid opening and closing device according to claim 1, further comprising a lock member movable between a lock position that engages with the lid at the closed position and an unlock position that disengages from the lid,
wherein the lid includes an arm having a pivot portion pivotally supported by the base, the arm being movable between a retracted position where the arm is retracted into the panel and the lid is arranged at the closed position and an advanced position where the arm is protruded to the outside of the panel and the lid is arranged at the open position, and
wherein the drive mechanism includes:
a rotating body that transmits a drive force received from the drive source to the pivot portion to move the arm between the retracted position and the advanced position;
a cam that rotates in conjunction with the rotating body;
a transmission member that is movable by the cam, transmits a rotational force of the rotating body transmitted via the cam to the lock member, and moves the lock member between the lock position and the unlock position; and
a differential mechanism that starts rotation of the pivot portion with a delay with respect to start of rotation of the rotating body when moving the lid at the closed position to the open position.

4. The lid opening and closing device according to claim 3,
wherein rotation axes of the pivot portion and the rotating body coincide with each other,
wherein the differential mechanism includes:
a convex portion provided on one of the pivot portion and the rotating body; and
a concave portion provided in the other one of the pivot portion and the rotating body and having the convex portion arranged therein,
wherein an angular range of the convex portion around a rotation axis of the pivot portion is smaller than an angular range of the concave portion around the rotation axis,
wherein a gap of a predetermined differential angular range is provided between the convex portion and the concave portion in a circumferential direction around the rotation axis, and
wherein rotation of the rotating body causes opposing surfaces of the convex portion and the concave portion in the circumferential direction to abut and press, thereby rotating the pivot portion.

5. The lid opening and closing device according to claim 2, further comprising a lock member movable between a lock position that engages with the lid at the closed position and an unlock position that disengages from the lid,
wherein the lid includes an arm having a pivot portion pivotally supported by the base, the arm being movable between a retracted position where the arm is retracted into the panel and the lid is arranged at the closed position and an advanced position where the arm is protruded to the outside of the panel and the lid is arranged at the open position, and
wherein the drive mechanism includes:
a rotating body that transmits a drive force received from the drive source to the pivot portion to move the arm between the retracted position and the advanced position;
a cam that rotates in conjunction with the rotating body;
a transmission member that is movable by the cam, transmits a rotational force of the rotating body transmitted via the cam to the lock member, and moves the lock member between the lock position and the unlock position; and
a differential mechanism that starts rotation of the pivot portion with a delay with respect to start of rotation of the rotating body when moving the lid at the closed position to the open position.

6. The lid opening and closing device according to claim 5,
wherein rotation axes of the pivot portion and the rotating body coincide with each other,
wherein the differential mechanism includes:
a convex portion provided on one of the pivot portion and the rotating body; and
a concave portion provided in the other one of the pivot portion and the rotating body and having the convex portion arranged therein,
wherein an angular range of the convex portion around a rotation axis of the pivot portion is smaller than an angular range of the concave portion around the rotation axis,
wherein a gap of a predetermined differential angular range is provided between the convex portion and the concave portion in a circumferential direction around the rotation axis, and
wherein rotation of the rotating body causes opposing surfaces of the convex portion and the concave portion in the circumferential direction to abut and press, thereby rotating the pivot portion.
